(19) United States
(12) Patent Application Publication
(10) Pub. No.: US 2014/0189889 A1
(43) Pub. Date: Jul. 3, 2014

(54) MANAGING AUTHORIZATION OF ACTIONS ASSOCIATED WITH DATA OBJECTS

(71) Applicant: Ab Initio Technology LLC, Lexington, MA (US)

(72) Inventor: Christopher James Winters, Lexington, MA (US)

(21) Appl. No.: 13/732,780

(22) Filed: Jan. 2, 2013

(51) Int. Cl. G06F 21/62

(52) U.S. Cl. CPC G06F 21/6209
USPC 726/30

(57) ABSTRACT

Managing actions associated with objects stored in a data storage system includes: receiving, over an input device or port, a request to determine authorization of an action associated with an object; and computing, with at least one processor, authorization information for processing the received request. The computing includes: determining a class of the object, retrieving a rule specification associated with the class, and evaluating at least one rule defined in the retrieved rule specification or defined in rule specifications associated with classes of any objects referenced in the retrieved rule specification.

### BACKGROUND This description relates to managing authorization of actions associated with data objects.

Various techniques can be used to control permissions (also called “access rights”) associated with objects within a filesystem. An object in the filesystem, such as a file, directory, or executable program, can be associated with a set of permission flags (also called “permission bits”) that grant a user or group (corresponding to a set of one or more users) access to that object. The name of a user or the name of a group can be identified explicitly (e.g., in an access control list) or implicitly (e.g., as the current owner of the object). If a flag associated with a particular object and a particular type of access is set, then permission for performing that type of access with respect to that object is granted. For example, if the object is a file, permission may be granted for a user to edit that file; or if the object is a program, permission may be granted for a user to execute that program. A user interface can be provided to enable a user to directly determine the permissions. In UNIX, a “chmod” command is provided to set flags for reading, writing, or executing an object; or, in Windows, a graphical interface is provided to either allow or deny permissions for various types of interactions. Access control lists (ACLs) can optionally be used to specify permissions for lists of named users or groups. In some systems, default permissions for an object can be acquired from an ACL for that object's containing directory (also called the “parent directory” or “parent container object”).

### SUMMARY

In one aspect, in general, a method for managing actions associated with objects stored in a data storage system includes: receiving, over an input device or port, a request to determine authorization of an action associated with an object; and computing, with at least one processor, authorization information for processing the received request. The computing includes: determining a class of the object, retrieving a rule specification associated with the class, and evaluating at least one rule defined in the retrieved rule specification or defined in rule specifications associated with classes of any objects referenced in the retrieved rule specification.

Aspects can include one or more of the following features.

Processing the received request includes determining whether the action is authorized to be performed in association with the object based on the authorization information.

At least a portion of the authorization information is computed before the request is received.

At least a portion of the authorization information is computed after the request is received.

Retrieving a rule specification associated with the class includes retrieving a rule specification associated with the class and associated with the action.

Retrieving a rule specification associated with the class includes determining whether the class has a corresponding rule specification, and if so retrieving the corresponding rule specification, and if not retrieving a rule specification of a class related to the class.

The class related to the class is related according to a class hierarchy.

The retrieved rule specification defines a rule that when evaluated determines at least a portion of the authorization information.

The retrieved rule specification includes a logical expression that refers to at least one attribute of the object or at least one attribute of an object related to the object.

At least one attribute referred to by the logical expression has a corresponding attribute value representing information about the object other than the authorization information.

Evaluating at least one rule defined in the retrieved rule specification includes evaluating a first rule on the object and evaluating a second rule on an object related to the object.

Evaluating at least one rule defined in the retrieved rule specification includes evaluating a first rule on the object and evaluating a second rule on an object related to the object.

The authorization information includes information specifying one or more user names.

The information specifying one or more user names includes information specifying at least one group to which the one or more user names belong.

The information specifying one or more user names includes information specifying at least one role assigned to the one or more user names.

The retrieved rule specification includes multiple statements, including a first statement that when evaluated returns a first set of one or more user names and a second statement that when evaluated returns a second set of one or more user names.

The information specifying one or more user names includes the union of the first set and the second set.

The action includes at least one of creating the object, deleting the object, or editing the object.

The request associated with authorization of the action associated with the object is received in response to an attempt to perform the action on the object.

The request associated with authorization of the action associated with the object is associated with a set of proposed changes to multiple objects.

The authorization information includes information specifying multiple sets of one or more user names, where at least two different sets of one or more usernames are associated with different respective objects of the multiple objects.

In another aspect, in general, software is stored on a computer-readable medium, for managing actions associated with objects stored in a data storage system. The software includes instructions for causing a computer system to: receive, over an input device or port, a request to determine authorization of an action associated with an object; and compute, with at least one processor, authorization information for processing the received request. The computing includes: determining a class of the object, retrieving a rule specification associated with the class, and evaluating at least one rule defined in the retrieved rule specification or defined in rule specifications associated with classes of any objects referenced in the retrieved rule specification.

In another aspect, in general, a computing system for managing actions associated with objects stored in a data storage system includes: an input device or port configured to receive a request to determine authorization of an action associated with an object; and at least one processor configured to compute authorization information for processing the received request. The computing includes: determining a class of the object, retrieving a rule specification associated with the class, and evaluating at least one rule defined in the retrieved rule specification or defined in rule specifications associated with classes of any objects referenced in the retrieved rule specification.

In another aspect, in general, a computing system for managing actions associated with objects stored in a data storage system includes: means for receiving a request to determine authorization of an action associated with an object; and means for computing authorization information for processing the received request. The computing includes: determining a class of the object, retrieving a rule specification associated with the class, and evaluating at least one rule defined in the retrieved rule specification or defined in rule specifications associated with classes of any objects referenced in the retrieved rule specification.

Aspects can include one or more of the following advantages.

The authorization techniques described herein enable rules to be defined for fine-grained control over authorization for objects organized by class. Additionally, by enabling the definition of default rules and by enabling inheritance chains from higher level classes to lower level classes in a class hierarchy, the rules can be more manageable for a large hierarchy of classes in an object model. Rules for authorizing an action on an object may be action-specific and attribute-specific. For example, a rule for editing a first attribute may be different from a rule for editing a second attribute. The rules may use arbitrary logic based on values of an object's attributes, or based on attributes of other objects that are reachable through a chain of references, to determine the authorized users. The rules may also combine class-specific logic with inheritance from related objects.

Other features and advantages of the invention will become apparent from the following description, and from the claims.

### DESCRIPTION OF DRAWINGS

FIG. 1 is a block diagram of a system for managing authorization of actions.

FIG. 2 is a diagram of a class hierarchy.

FIG. 3 is a flowchart of an exemplary authorization procedure.

### DESCRIPTION

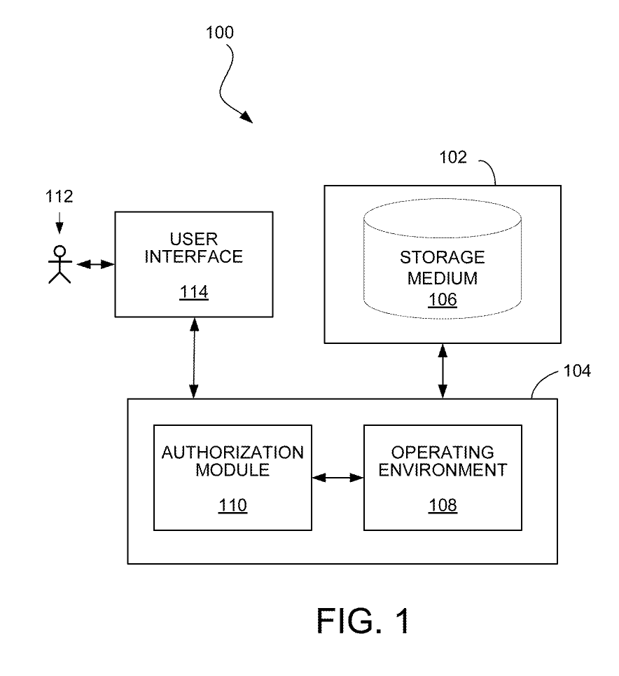

FIG. 1 shows an exemplary data management system 100 in which the authorization techniques can be used. The system 100 includes a data storage system 102 that provides a computing environment 104 of a computing system or device access to data stored in a storage medium 106. The data storage system 102 may be local to the computing system or device (e.g., an internal hard drive), or the data storage system 102 may be external to the computing system or device (e.g., a remote storage device or server). The data stored in the data storage system 102 include objects that are each an instance of a particular class of data object. Information that specifies different aspects of a class includes a rule specification that defines one or more authorization rules that are evaluated as part of authorizing different actions associated with objects that are instances of that class. The actions may include, for example, creating an object, deleting an object, editing (or “writing”) an object (e.g., changing values of an object's attributes), or displaying content of (or “reading”) an object. Another aspect of a class that may be specified is its relationships to other classes, and objects that are instances of those classes may be expected to have those specified relationships. For example, Section class may reference a Newspaper class a “parent” class. An object that is an instance of the Section class may be expected to have a reference to a corresponding object that is an instance of the Newspaper class. In some cases, there is allowed to be at most one class designated as a parent class to a particular child class (though a particular parent class may be referenced by multiple child classes). In those cases, a class may be related to any number of other classes, and at most one of those related classes is allowed to be designated as the “parent” class.

The computing environment 104 includes an operating environment 108 (e.g., an operating system) that executes programs that interact with the data in the data storage system 102. The computing environment 104 may be hosted on one or more computers, and the operating environment 108 can include a local operating system, or a multiple-node parallel computing environment hosted by a configuration of computer systems using multiple central processing units (CPUs), either local (e.g., multiprocessor systems such as SMP computers), or locally distributed (e.g., multiple processors coupled as clusters or MPPs), or remote, or remotely distributed (e.g., multiple processors coupled via a local area network (LAN) and/or wide-area network (WAN)), or any combination thereof.

The computing environment 104 also includes an authorization module 110 that manages requests for authorizing actions that affect existing objects or create new objects. The authorization module 110 processes requests to determine authorization information for authorizing the actions. The actions to be authorized are associated with a particular user 112 (e.g., a user that logs in under a particular user name), and requests for authorization of the actions may be directly or indirectly initiated by the user 112. In some cases, the requests are initiated by the user 112 interacting with a user interface 114 (e.g., a graphical view on a display arranged for receiving input from one or more input devices). In some cases, the requests are initiated by programs executing in the operating environment 108 on behalf of the user without requiring the user 112 to interact with the user interface 114.

A given request for authorization is associated with a single action on a single object. The request authorization may also be associated with a single user, or authorization for all possible users may be pre-computed before any specific user requests authorization. The authorization information determined by the authorization module 110 in response to the request specifies a set of zero or more authorized users. If the requesting user is in the set of authorized users, then the proposed action(s) are permitted. If the requesting user is not in the set of authorized users, then proposed action(s) are not permitted.

Whether requesting authorization for a single user or pre-computing for all users, the authorization module 110 supports a compound request that address multiple actions and multiple objects. The compound response will specify authorized users for each combination of action and object.

The set of authorized users can be specified in different ways. In some cases, a specific user is named or a specific group of multiple users is named. In some cases, the set of authorized users is specified by specifying the attributes a user must have in order to be an authorized user. For example, the user name identifying a user (e.g., stored as a string of characters) may be assigned any number of roles (e.g., also strings of characters). The authorization information can include a list of roles must be assigned to an authorized user

When a request for authorization of an action associated with an object is received, the authorization module 110 determines the authorization information based on any authorization rules that may apply to the object. A rule specification associated with a particular class defines respective rules for each of one or more actions that may be performed on an object of that class. To determine what rules apply for a particular action to be performed on a particular object, the module 110 determines the class of the object, and retrieves a rule specification associated with the determined class and determines the appropriate rule to be evaluated for the action to be performed with respect to that object. The rule specification associated with the object's class can include an explicit statement to inherit a rule associated with another class, as described in more detail below. For example, the explicit statement can include a reference to another object, enabling the object's class to inherit rules defined in rule specifications associated with any referenced object's class.

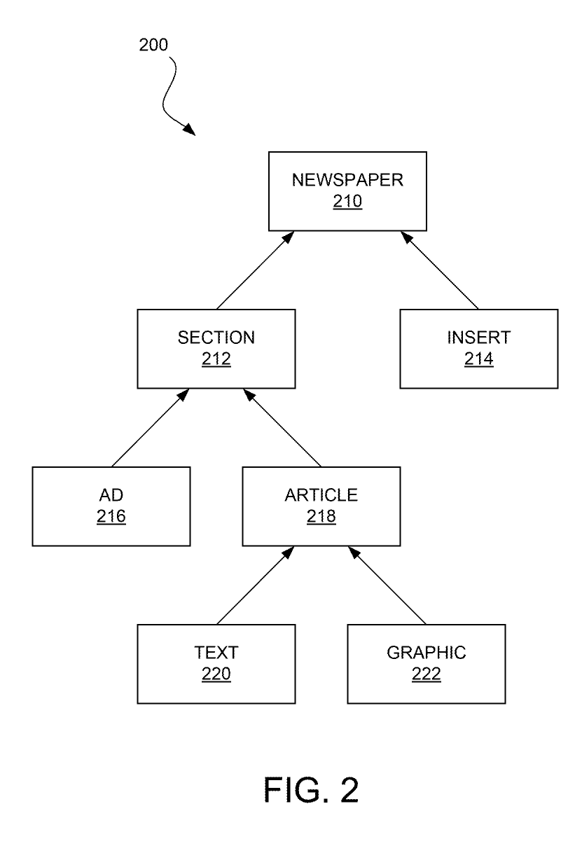

If there is no rule specification associated with the class of an object or no rule defined for the particular action to be performed, the module 110 retrieves a default rule specification. In some implementations, the default rule specification indicates that a rule for a class related to the object's class according to predetermined class relationships, such as relationships in a class hierarchy, is to be inherited. For example, the default rule specification may indicate that a rule for the parent class is to be inherited if such a rule specification exists, as described in more detail below. FIG. 2 shows an example of a class hierarchy 200 represented by a diagram with nodes representing classes and with directed edges representing a reference from a referencing class to a referenced parent class. The hierarchy 200 includes a Newspaper class 210 at the root of the hierarchy, which is referenced by a Section class 212 and an Insert class 214. The Section class 212 is referenced by an Ad class 216 and an Article class 218, and the Article class 218 is referenced by a Text class 220 and a Graphic class 222.

A rule specification can include logical expressions that express a rule for determining what users are included in a set of authorized users. A logical expression can include conditional logic (e.g., an if-then-else statement, or a case statement), and other programming logic including references to objects, users, or other rules. For example, a logical expression may refer to an attribute of an object or an attribute of an object related to another object (e.g., reachable via a chain of foreign key relationships). An attribute referred to by the logical expression may have a corresponding attribute value representing various kinds of information about the object (e.g., an object's name, description, or other object-specific characteristics that depend on what the object represents). A logical expression in one rule specification may refer to authorization information (e.g., a set of authorized users) resulting from evaluation of a rule defined in another rule specification.

One way for the rule specification to be associated with a particular class is by including a portion that explicitly identifies that class by name. Alternatively, the rule specification can be implicitly associated with a particular class, for example, by being stored in a location corresponding to that class. Some rule specifications may be associated with multiple classes.

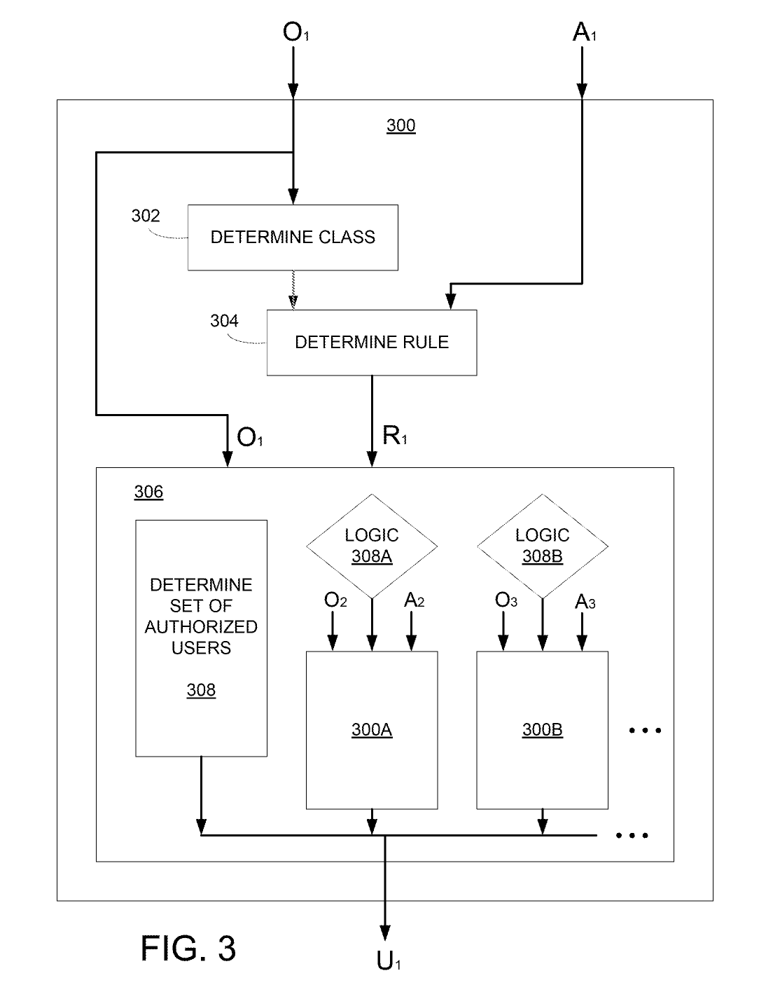

FIG. 3 shows a diagram for an exemplary sub-module 300 of the authorization module 110, which receives as input a particular action A₁ associated with a particular object O₁, and determines a corresponding set of authorized users U₁. The authorization module 110 receives a request to determine authorization of the action A₁ associated with the object O₁, and the sub-module 300 computes authorization information for processing the received request. The authorization information determines the corresponding set of authorized users U₁. The sub-module 300 determines (302) a class of the object. The sub-module 300 retrieves a rule specification associated with the determined class, which may involve retrieving a default rule specification. In some implementations, the default rule specification leads to navigating a class hierarchy of an object model (e.g., from a directed acyclic graph that designates at most one parent class related to a particular class), and/or retrieving a particular default rule specification if no parent class has been designated. The sub-module 300 determines (304) a rule R₁ corresponding to the determined class and the action A₁. The sub-module 300 evaluates the rule R₁ with respect to the object O₁ using a procedure 306 that represents evaluation of rules defined in rule specifications associated with classes of any objects referenced in the retrieved rule specification. In some cases, the procedure 306 uses recursive application of rules, which is illustrated in the example of FIG. 3 by inclusion of other instances of sub-module 300 (labeled as 300A and 300B) within the evaluation procedure 306. In particular, the procedure 306 includes a base case 308 that determines a set of authorized users, which is combined with users determined by any number of recursive instances of the sub-module 300 (by taking the union of the sets of users). The procedure 306, as it evaluates rule R₁ with respect to the object O₁, will determine the objects (O₂, O₃, etc.) and actions (A₂, A₃, etc.) to be used for the recursive sub-modules (300A, 300B, etc.). For example, suppose that object O₁ represents a newspaper article and that action A₁ is the CREATE action for newspaper articles. If an editor of a newspaper section should be permitted to create articles within his section, and then rule R₁ may specify that object O₂ is the newspaper section corresponding to newspaper article O₁, while action A₂ would be the EDIT action. Conditional logic can optionally be included in any rule specification. In this example, conditional logic 308A determines whether instance 300A is applied and its input action A₂ and object O₂, and conditional logic 308B determines whether instance 300B is applied and its input action A₃ and object O₃.

Examples of syntax and structure for programming rule specifications are provided below. In some of the following examples, multiple actions are referenced directly in the rule specification and the authorization module 110 processes requests to determine whether a proposed action on a particular object is authorized. Another example is also described later in which a single action is implied. In a first set of examples, a user that has the authority to define the authorization rules is able to use tags to specify a class associated with a rule specification, key words to specify the actions to be controlled using the rule specification, and configurable logic to determine the set of authorized users that should result from evaluating the defined rule. The generic example of a rule specification below includes a “class:” tag followed by name(s) of one or more classes to which the rule specification is assigned. The rule specification below also includes multiple “action:” tags that are each followed by name(s) of one or more actions that are to be controlled by a following “rule body” that can include a logical expression (potentially over multiple lines).

```
class: <class 1>, <class 2>, . . .
action: <action 1>, <action 2>, . . .
      <rule body 1>
action: <action 3>, <action 4>, . . .
      <rule body 2>
```

The names of classes of the objects stored in the data storage system 102 are determined, for example, according to an object model. The classes can be defined in the object model with relationships among the classes. For example, some classes can be defined as having a parent-child relationship to another class. A hierarchical structure (e.g., a tree) can exist with a single object class at the root. In such an object model, a child class may be able to inherit properties from a parent class or from any class within an “inheritance chain” from that child class to the root class.

The “class:” tag can be followed by the name of one or more classes in the object model. One of the following key words may also follow the “class:” tag: DEFAULT, ROOT. The DEFAULT key word identifies the rule specification that is used in the event that the class of an object associated with the authorization request does not have an associated rule specification. The ROOT key word identifies a rule specification that is used in the event that a parent class is referenced for a particular class, but that particular class that does not have a parent class in the object model.

The “action:” tag can be followed by one of the following key words: CREATE, DELETE, EDIT, or EDIT/<attribute>. The CREATE key word identifies an action that creates a new object that is an instance of a class listed after the “class:” tag. The DELETE key word identifies an action that deletes an existing object that is an instance of a class listed after the “class:” tag. The EDIT and EDIT/<attribute> key words identify an action that edits an existing object that is an instance of a class listed after the “class:” tag, with the optional “/<attribute>” qualifier indicating that a particular attribute defined in the object model is to be edited.

The rule body following the list of one or more actions may include any number of statements. Each statement may optionally include a logical expression using a predetermined syntax, and includes zero or more function calls for determining a set of zero or more authorized users or for inheriting a rule from another class or from another action of the same class. If a rule body is empty, the corresponding actions are not allowed, resulting in an empty set of authorized users when the rule defined by the rule specification is evaluated. The resulting set of authorized users for a particular class:action pair in the rule specification is the union of the sets of authorized users from each statement in the rule body. In this example, there are three possible function calls that can be included in a statement of a rule body: ALLOW ROLE(<role>), ALLOW_VIA_PRINCIPAL_ATTR(<P_attribute>), and INHERIT_FROM(<reference:action>).

Each pair of occurrences of a particular class after the “class:” tag and a particular action after the “action:” tag should be associated with no more than a single rule body of a single rule specification. A particular class can occur in more than one rule specification (after the “class:” tag), but only if the different occurrences are followed by different action key words (after the “action:” tag).

Some statements within a rule body can refer to local attributes of an object (as defined in the object's class definition), as well as to non-local attributes of other objects that can be referenced through a chain of foreign key references. For example, an object may have an attribute who's value is a foreign key that identifies another object. To refer to a local attribute, a statement includes “this.<attribute>” where <attribute> is a name of a local attribute. To refer to a non-local attribute, a statement includes the intervening foreign key references, as in the following example that uses dot notation: “this.<obj1>.<obj2>.<attribute>” where <obj1> is a foreign-key referenced object related to the current object, <obj2> is a foreign-key referenced object related to object <obj1>, and <attribute> is the name of an attribute of <obj2>. If the action is EDIT or DELETE, the rule body can refer to any local attribute of the current object, but if the action is CREATE, local attributes do not yet exist for the object being created, but the rule body can still refer to local attributes of the parent object of the object being created using “parent.<attribute>”.

For the ALLOW_ROLE(<role>) function call, the <role> argument is the name of a role that must be assigned to a user that is to be a member of the set of authorized users returned by the function call. This function can be called any number of times in different statements of a rule body to authorize different sets of users, or to conditionally authorize certain sets of users, according to what roles they have been assigned.

For the ALLOW_VIA_PRINCIPAL_ATTR(<P_attribute>) function call, the <P_attribute> argument is a local or non-local reference to a “principal attribute” that whose value corresponds to a “principal” which identifies a specific set of one or more users to be included in the set of authorized users returned by the function call. The value of the attribute can be a name of a user or group, or a role that is assigned to users of the set. This function can also be called any number of times in different statements of a rule body to authorize different sets of users, or to conditionally authorize certain sets of users, by name.

The set of authorized users resulting from one rule can be used in another rule through the use of the INHERIT_FROM(<reference:action>) function call. The “reference” of the “reference:action” pair can be “this.attribute” to represent a reference to a related object or one of the key words DEFAULT or ROOT, or “this” to represent the current object (the class of the current object associated with the authorization request being processed), or “parent” to represent the parent object of the current object. The “action” of the “reference:action” pair is the particular name of the action from which a rule is to be inherited, according to the rule body following that identified action in the rule specification associated with the identified class. This function can also be called any number of times in different statements of a rule body to inherit rules from multiple reference:action pairs, in which case the union is taken of the resulting sets of authorized users.

In the following example, a rule specification associated with the class Newspaper includes two statements that are each a simple function call to specify roles of users authorized to create, edit, and delete objects that are instances of the Newspaper class.

```
class: Newspaper
      action: CREATE, EDIT, DELETE
            ALLOW_ROLE(‘Writer’);
            ALLOW_ROLE(‘Editor’);
```

In the above example, objects that are instances of the class Newspaper can be created, edited, or deleted by users that have been assigned either of the roles: Writer, or Editor.

In the following example, a rule specification associated with the class Article includes two statements, including one that inherits the rule defined in the rule specification above for the Newspaper class. In this example, objects that are instances of the class Article have an attribute (called “newspaper”) that identifies an object that is an instance of the class Newspaper.

```
class: Article
      action: EDIT
            INHERIT_FROM(this.newspaper:EDIT);
            ALLOW_ROLE(‘Photographer’);
```

In the above rule specification, one of the statements of the rule body includes a reference to a local attribute of the current Article object to an object that is an instance of the Newspaper class, which is used as the “class” in the “class:action” pair. The result, based on both rule specifications above, is that objects that are instances of the class Article can be edited by users that have been assigned any of the roles: Writer, Editor, or Photographer.

There may be some restrictions on what kinds of references can be included in a rule specification. For example, objects that have not yet been created do not have any attribute values to be referenced. So, statements in a rule body for a CREATE action are allowed to include references to attributes of a parent object, but not references to local attributes. While, statements in a rule body for an EDIT or DELETE action are allowed to include both references to attributes of parent objects and references to local attributes.

The statements in a rule body can include conditional logical expressions. For example, in the following rule specification, a Section object (an object that is an instance of the Section class) can be created by a user with either the Opinion Editor role or the Sports Editor role, but an existing Section object can only be edited (or deleted) by an Opinion Editor if its Type attribute is Opinion and can only be edited (or deleted) by a Sports Editor if its Type attribute is Sports. A Section object can also be created, edited, or deleted by a user with a Local Editor role if the Edition attribute of the parent object (of class Newspaper) is Local.

```
class: Section
      action: CREATE
            ALLOW_ROLE(‘Opinion Editor’);
            ALLOW_ROLE(‘Sports Editor’);
            if (parent.Edition == ‘Local’)
            ALLOW_ROLE(‘Local Editor’);
      action: EDIT, DELETE
            switch (this.Type)
                  case ‘Opinion’:
                  ALLOW_ROLE(‘Opinion Editor’);
                  case ‘Sports’:
                  ALLOW_ROLE(‘Sports Editor’);
            end
            if (parent.Edition == ‘Local’)
            ALLOW_ROLE(‘Local Editor’);
```

In some implementations, the rules associated with the class key words DEFAULT and ROOT are pre-configured to provide a particular type of default authorization behavior. The rule specification associated with the key word DEFAULT is used for a particular class:action pair if that pair does not exist in any rule specification (or if the rule specification has an empty rule body for that class:action pair). If a rule specification indicates that a rule should be inherited from an object's parent class, but an object class has no parent class (according to the object model), then the rule specification associated with the key word ROOT is used. One type of default authorization behavior is based on the following two general rules: (1) a user is authorized to create a new object of a particular class if that user is authorized to edit an existing object of the parent class of that particular class; (2) a user is authorized to edit or delete an existing object of a particular class if that user is able to create a new object of that particular class. These two general rules can be expressed in rule specifications as follows.

```
class: DEFAULT
      action: CREATE
            INHERIT_FROM(parent:EDIT);
      action: EDIT, DELETE
            INHERIT_FROM(this:CREATE);
```

These default rules allow authorization specified on high-level classes to propagate down to child classes. This default alternation of EDIT to CREATE (from parent class to child class), of CREATE to EDIT/DELETE (within a class), and so forth, allows authorization to be customized at either the CREATE or EDIT level of a particular class in the object model hierarchy and impact all descendent object classes that are below that particular class in the hierarchy. Along with this type of default authorization behavior, the rule specification associated with the key word ROOT can specify a particular role (indicated below as “<role>”) to provide an initial default set of authorized users.

```
class: ROOT
      action: EDIT
            ALLOW_ROLE(<role>);
```

Examples of various types of specification rules that are possible are provided below.

While specific roles can be specified in a rule specification in advance before an authorization request is processed, using the ALLOW_ROLE(<role>) function call, roles can also be retrieved when processing the request from a stored value of an object's principal attribute, using the ALLOW_VIA_PRINCIPAL_ATTR(<P attribute>) function call. In the following example, the Article class has a principal attribute called author, and a particular instance of the Article object has the attribute author set to ‘Joe Smith’. The following example of a rule specification when evaluated during an authorization request associated with that instance of the Article object authorizes user ‘Joe Smith’ to edit the object, along with users authorized to create Article class objects.

```
class: Article
      action: EDIT
            INHERIT_FROM(this:CREATE);
            ALLOW_VIA_PRINCIPAL_ATTR(this.author);
```

In the following example, a rule for editing objects of the Article class is specified. In this example, objects that are instances of the class Article have an attribute (called “newspaper”) that identifies an object that is an instance of the class Newspaper. A rule for editing an Article object can be specified so that if a user can edit an Article's Newspaper object, that user can also edit the Article object. An example of such a rule specification is as follows.

```
class: Article
      action: CREATE, DELETE
            INHERIT_FROM(parent:EDIT);
      action: EDIT
            INHERIT_FROM(this:CREATE);
            INHERIT_FROM(this.newspaper:EDIT);
```

The following is an example of an attribute-specific rule. In the following rule specification, a user is specified by an attribute author is used to control editing of most the Article object's attributes. But, there is a different role, ‘Managing Editor’ to control editing of the author attribute itself The following attribute-specific EDIT rule can be used.

```
class: Article
      action: EDIT
            INHERIT_FROM(this:CREATE);
            ALLOW_VIA_PRINCIPAL_ATTR(this.author);
      action: EDIT/author
            ALLOW_ROLE(‘Managing Editor’);
```

The following is an example of customizing a default rule specification. If users assigned the ‘Managing Editor’ role are to be responsible for setting author attributes for all object classes, then the following default rule specification can be used.

```
class: DEFAULT
      action: EDIT/author
            ALLOW_ROLE(‘Managing Editor’);
```

A rule specification for a specific class will always override the default rule. The authorization for an attribute <attribute> of an instance of an object of class <class> is determined by the first rule that is specified in the following in precedence order.

<class>:EDIT/<attribute>
DEFAULT:EDIT/<attribute>
<class>:EDIT
DEFAULT:EDIT

Other types of syntax and structure for programming rule specifications for authorization rules can be used. For example, the authorization module 110 can be configured to determine whether a user is authorized to approve proposed actions on objects by other users. In some implementations of this approach, the rule specification still uses a “class:” tag to specify one or more classes, but there are no actions specified since the only action is an implicit “approve” action. The rule body directly follows the class list

The authorization module 110 can be configured to store results of evaluating rules in the data storage system 102 (or in a local cache or other location accessible to the computing environment 104) for later retrieval in response to different authorization requests. For example, if a rule body for a particular class and action does not contain any references to the current object (e.g., using “this.”) then the rule defined by that rule body only needs to be evaluated once for that action being applied to any objects of that class. In some implementations, default rules for some classes can also be evaluated in advance to increase performance in cases where many objects may have classes that lack specific rule specifications.

The authorization module 110 can also be configured to maintain information that enables it to bypass rule evaluation in certain circumstances. For example, if a rule and its inherited rules do not use the function ALLOW_VIA_PRINCIPAL_ATTR( ) then the module 110 can maintain a list of all possible users for the rule. Then before rule evaluation of a rule for which such information is present, the module 110 can determine based on the roles assigned to a user proposing an action if the user would ever possibly be authorized. If not, the server can bypass the rule evaluation and simply return an empty set of authorized users.

A variety of alternative implementations of these authorization approaches can provide equivalent functionality. For example, instead of determining users that are authorized to perform various actions, the authorization module 110 can determine users that are not authorized to perform various actions. The functions available to be used in a rule body can include functions that specify roles or users or groups that are not authorized instead of, or in addition to, functions that specify roles or users or groups that are authorized. Resolution procedures can be used to resolve conflicts between specification of a user as both authorized and not authorized (e.g., the specification of a user as not authorized can take precedence). In systems in which objects are being sent between a client and a server, authorization can take place on the client side, server side, or both.

The authorization approaches described above can be implemented using a computing system executing suitable software. For example, the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of dataflow graphs. The modules of the program (e.g., elements of a dataflow graph) can be implemented as data structures or other organized data conforming to a data model stored in a data repository.

The software may be provided on a tangible, non-transitory medium, such as a CD-ROM or other computer-readable medium (e.g., readable by a general or special purpose computing system or device), or delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, is to be understood that the foregoing description is intended to illustrate and not to limit the scope of the invention, which is defined by the scope of the following claims.

Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A method for managing actions associated with objects stored in a data storage system, the method including:
receiving, over an input device or port, a request to determine authorization of an action associated with an object; and
computing, with at least one processor, authorization information for processing the received request, the computing including
determining a class of the object,
retrieving a rule specification associated with the class, and
evaluating at least one rule defined in the retrieved rule specification or defined in rule specifications associated with classes of any objects referenced in the retrieved rule specification.

2. The method of claim 1, wherein processing the received request includes determining whether the action is authorized to be performed in association with the object based on the authorization information.

3. The method of claim 1, wherein at least a portion of the authorization information is computed before the request is received.

4. The method of claim 1, wherein at least a portion of the authorization information is computed after the request is received.

5. The method of claim 1, wherein retrieving a rule specification associated with the class includes retrieving a rule specification associated with the class and associated with the action.

6. The method of claim 1, wherein retrieving a rule specification associated with the class includes determining whether the class has a corresponding rule specification, and if so retrieving the corresponding rule specification, and if not retrieving a rule specification of a class related to the class.

7. The method of claim 6, wherein the class related to the class is related according to a class hierarchy.

8. The method of claim 1, wherein the retrieved rule specification defines a rule that when evaluated determines at least a portion of the authorization information.

9. The method of claim 8, wherein the retrieved rule specification includes a logical expression that refers to at least one attribute of the object or at least one attribute of an object related to the object.

10. The method of claim 9, wherein at least one attribute referred to by the logical expression has a corresponding attribute value representing information about the object other than the authorization information.

11. The method of claim 9, wherein evaluating at least one rule defined in the retrieved rule specification includes evaluating a first rule on the object and evaluating a second rule on an object related to the object.

12. The method of claim 8, wherein evaluating at least one rule defined in the retrieved rule specification includes evaluating a first rule on the object and evaluating a second rule on an object related to the object.

13. The method of claim 1, wherein the authorization information includes information specifying one or more user names.

14. The method of claim 13, wherein the information specifying one or more user names includes information specifying at least one group to which the one or more user names belong.

15. The method of claim 13, wherein the information specifying one or more user names includes information specifying at least one role assigned to the one or more user names.

16. The method of claim 13, wherein the retrieved rule specification includes multiple statements, including a first statement that when evaluated returns a first set of one or more user names and a second statement that when evaluated returns a second set of one or more user names.

17. The method of claim 16, wherein the information specifying one or more user names includes the union of the first set and the second set.

18. The method of claim 1, wherein the action includes at least one of creating the object, deleting the object, or editing the object.

19. The method of claim 1, wherein the request associated with authorization of the action associated with the object is received in response to an attempt to perform the action on the object.

20. The method of claim 1, wherein the request associated with authorization of the action associated with the object is associated with a set of proposed changes to multiple objects.

21. The method of claim 20, wherein the authorization information includes information specifying multiple sets of one or more user names, where at least two different sets of one or more usernames are associated with different respective objects of the multiple objects.

22. Software stored on a computer-readable medium, for managing actions associated with objects stored in a data storage system, the software including instructions for causing a computer system to:
receive, over an input device or port, a request to determine authorization of an action associated with an object; and
compute, with at least one processor, authorization information for processing the received request, the computing including
determining a class of the object,
retrieving a rule specification associated with the class, and
evaluating at least one rule defined in the retrieved rule specification or defined in rule specifications associated with classes of any objects referenced in the retrieved rule specification.

23. A computing system for managing actions associated with objects stored in a data storage system, the computing system including:
an input device or port configured to receive a request to determine authorization of an action associated with an object; and
at least one processor configured to compute authorization information for processing the received request, the computing including
determining a class of the object,
retrieving a rule specification associated with the class, and
evaluating at least one rule defined in the retrieved rule specification or defined in rule specifications associated with classes of any objects referenced in the retrieved rule specification.

24. A computing system for managing actions associated with objects stored in a data storage system, the computing system including:
means for receiving a request to determine authorization of an action associated with an object; and
means for computing authorization information for processing the received request, the computing including
determining a class of the object,
retrieving a rule specification associated with the class, and
evaluating at least one rule defined in the retrieved rule specification or defined in rule specifications associated with classes of any objects referenced in the retrieved rule specification.
